(19) United States
(12) Patent Application Publication
(10) Pub. No.: US 2008/0175569 A1
(43) Pub. Date: Jul. 24, 2008

(54) Extension of Media Player Environments

(76) Inventor: Mark Rogers Johnson, Pasadena, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/851,321

(22) Filed: Sep. 6, 2007

Related U.S. Application Data
(60) Provisional application No. 60/886,248, filed on Jan. 23, 2007.

(51) Int. Cl. H04N 5/00

(52) U.S. Cl. 386/125

(57) ABSTRACT

The systems and methods of extending the capabilities of media players included in or with a computing device are disclosed. The systems and methods provide a way for content that fully complies with a given media format specification to utilize network capabilities defined by that specification to create a bridge to an application and resources on the same platform that extend beyond those defined within the media format specification.

### RELATED APPLICATION INFORMATION

This patent claims the benefit of Provisional Application No. 60/886,248 filed Jan. 23, 2007 which is incorporated herein by reference in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to digital video and the playback of digital video on personal computers and other computing devices.

2. Description of the Related Art

Technical specifications for media formats such as the HD DVD-Video and Blu-ray Disc formats are defined to allow playback of rich multimedia content on both standalone consumer electronic devices (e.g., set-top DVD players) and personal computer (PC) environments. In order to satisfy the former case, the specifications define a closed system with constrained resources such as memory, decoders, disc drives, etc. A closed system is defined to keep manufacturing costs of playback devices low and performance predictable. The PC environment, however, often offers abundant resources, applications, and capabilities that greatly exceed those of a consumer electronic device. However, these additional resources and capabilities remain beyond the scope of media format specifications. For example, media format specifications fail to standardize a method for activating or communicating with an external application that is running on the same computer system as the media player software. Likewise, media format specifications do not define a mechanism for directly transferring significant amounts of data between the media content and such an external application.

The situation described is prevalent with the DVD-Video format. Because the DVD-Video format specifications define no mechanism for extending the format in a standardized manner, player software written for the PC platform is typically limited to the functionality specified in the DVD-Video format specifications. Content playing back from within the player software essentially operates in a virtual player or “sandbox”, walled off from all of the additional capabilities and resources of the PC platform.

Several attempts were made to circumvent these limitations. The most notable was the PCFriendly software developed by InterActual Technologies, Inc. This software essentially “wrapped” itself around existing DVD player software in order to closely monitor the playback environment. As changes took place in the playback environment, such as playing from one chapter to another, or jumping from one title to another, the PCFriendly software would generate programmatic events to which additional PC applications could respond. In this way, the PC applications maintain some synchronicity with the video playback. In addition, the PC applications issue playback control commands, simulating user input like play, pause, stop, etc. Unfortunately, the content playing back within the player operates within the DVD-Video “bubble”, unaware and with no direct access to the external applications. Only through certain authoring tricks is it possible for the DVD-Video content to determine that it was operating within such an environment, and even then it could be easily fooled. In addition, there is no mechanism for directly transferring either data or commands between the two contexts.

### DESCRIPTION OF THE DRAWINGS

FIG. 1 is a drawing of an example environment in which a method of extending media player environments may be implemented.

FIG. 2 is a block diagram showing the software and other components of an embodiment of a system that implements a method of extending media player environments.

FIG. 3 is a flow chart showing the actions of a server implementing a method of extending media player environments.

FIG. 4a is a drawing showing the actions taken by a client and a server in a first embodiment of a client-server connection process.

FIG. 4b is a drawing showing the actions taken by a client and a server in a second embodiment of a client-server connection process.

FIG. 5 is a drawing showing the actions taken by a client and a server to launch and communicate with an application to extend a media player environment.

### DETAILED DESCRIPTION

Throughout this description, the embodiments and examples shown should be considered as exemplars, rather than limitations on the apparatus and methods disclosed or claimed.

The systems and methods described herein provide a way for content that fully complies with a given media format specification may utilize network capabilities defined by that specification to create a bridge to an external application and resources on the same platform that extend beyond those defined within the media format specification.

### ENVIRONMENT

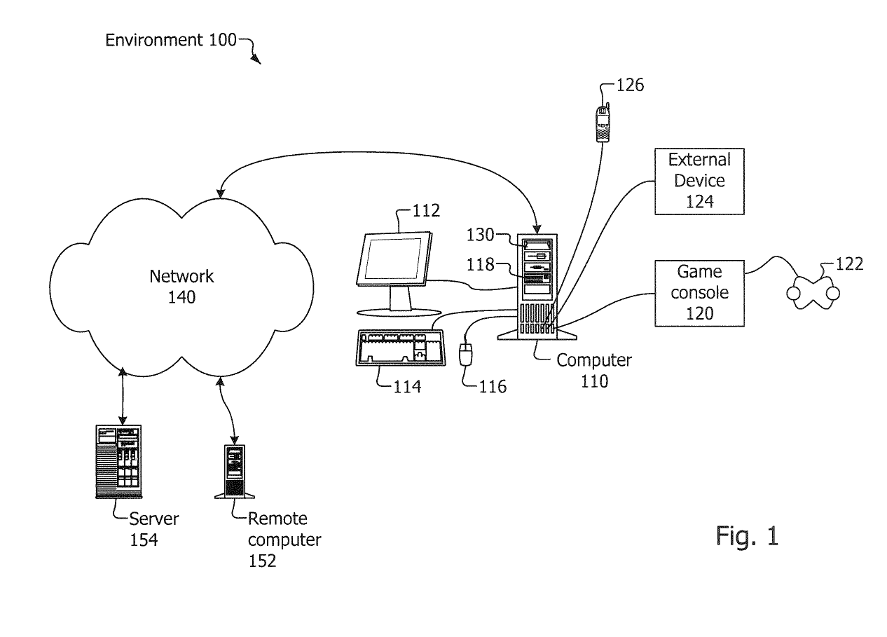

Referring now to FIG. 1, a drawing of an example environment in which a method of extending media player environments may be implemented is shown. The environment includes a personal computer 110 that may or may not be coupled to a network 140. The personal computer 110 may have external devices (including, for example, external device 124, game console 120, cellular telephone 126, personal video recorder (not shown), personal media device (not shown)) coupled to it.

Pertinent to the disclosure presented herein, the personal computer 110 includes a media player such as, for example, the combination of a hardware media device 130 such as a Digital Versatile Disc Read Only Memory (DVD-ROM) drive, a High Density (HD) DVD-ROM drive, a Blu-ray Disc Read Only Memory (BD-ROM) drive, or a streaming media card, and playback software that is capable of playing the media made accessible by the hardware device. As used herein, the term “media player” refers to hardware media devices and similar video disk and/or media playing devices as well as other sources of media, including streaming media cards including related software and devices. The term “streaming media cards” refers to digital television receiver cards and devices including cable television cards, fibre optic television cards, Internet Protocol television (IPTV) cards, Digital Video Broadcasting Multimedia Home Platform (DVB-MHP, also known as MHP) cards, OpenCable Application Platform (OCAP) cards, and others, including associated software that may be included on a card or executed on a personal computer or other computing device. The hardware player devices and/or the streaming media cards may include hardware, firmware, and/or software to support receipt and processing of streaming media according to well-known and/or proprietary protocols, including Moving Pictures Experts Group (MPEG) 2, MPEG-4, MPEG-7, IPTV, Globally Executable MHP (GEM), DVB-MHP, DVB-Java, DVB-HTML, OCAP and others.

The personal computer 110 may include other components which are not discussed herein. The personal computer 110 may include or be coupled with a display 112. The personal computer 110 may be coupled with or include one or more user input devices, including, for example, keyboard 114, mouse 116, a track ball, a scroll wheel, a touch pad, a key pad, a touch screen, navigation buttons, a joystick, a pen and tablet, a stylus and touchscreen, and/or others. A user may use a user input device to click on, select, or otherwise activate or control a user interface item such as a button, link, slider, etc. and to provide input to the operating system or programs running on the personal computer via a graphical user interface, text interface or other user interface provided on the personal computer 110.

The personal computer 110 may include communications hardware and software that allows for wired and/or wireless communication over network 140 and for wired and/or wireless communication with external devices such as, for example, game console 120, cellular telephone 126, external device 124, personal video recorder (not shown), and others.

In the environment 100, a personal computer 110 may be coupled with and communicate over network 140 with one or more servers 154, remote computers 152 and other computing devices. The personal computer 110 may be coupled with and communicate over network 140 via a wired or wireless connection. The computer 110 may include a network interface card, network chip, or network chip set and associated software that allows for communication over network 140. Network 140 may be a circuit-switched network, a packet-switched network, or a combination thereof. Network 140 may be or include the Internet, and may be a private network, local area network (LAN), wide area network (WAN), other network, or combination thereof.

The personal computer 110 may be coupled with zero or more external devices such as game console 120, including, for example, versions of the Sony Playstation, Nintendo Wii, Microsoft Xbox, and others; cellular telephone 126; and/or other external devices 124 such as, for example, a printer, a sound system or emitter, a smell emitter, a water sprayer, a biometric device, a projector, a personal media player, such as MP3 and video players, for example, Apple iPod and Microsoft Zune, a personal video recorder or digital video recorder, and others. The personal computer 110 may be coupled with and communicate with the external devices via wired and/or wireless communications, such as, for example, Universal Serial Bus (USB), IEEE 1394 (also known as Firewire® and i.link®), infrared, WiFi (also known as IEEE 802.11), Bluetooth, other IEEE 802 standards, and others, as well as via proprietary communications techniques.

The personal computer 110 may include software for providing some of the functionality and features described herein. The functionality and features may be embodied in whole or in part in software, also referred to herein as code, which operates on a client computer and may be in the form of firmware, an application program, an applet (e.g., a Java applet), a browser plug-in, a COM object, a dynamic linked library (DLL), a script, one or more subroutines, one or more modules, and/or an operating system component or service. The term “software” includes source code, executable code, compiled code, object code, microcode, and others in a high-level, compiled, interpreted, run-time, assembler or machine language. The software and its functions may be distributed such that some components are performed by personal computer 110 and others by other computing devices.

Although shown implemented in personal computer 110, the methods described herein may be implemented with various computing devices. A computing device as used herein refers to a device with a processor, memory and a storage device that may execute instructions including, but not limited to, personal computers, server computers, notebook computers, workstations, computing tablets, set top boxes, video game systems, gaming consoles, personal video recorders, telephones (cellular, wireless, wired, etc.), personal digital assistants (PDAs), portable computers, and laptop computers. These computing devices may run an operating system, including, for example, variations of the Linux, Unix, MS-DOS, Microsoft Windows, Palm OS, Solaris, Symbian, and Apple Mac OS X operating systems. To achieve the features and functionality described herein, a computing device includes, is coupled with and/or is in communication with a media player.

The techniques described herein may be implemented as software which is stored on a storage media or delivered via broadcast or network via a wire, cable, fiber optic line and/or wirelessly and/or via satellite from a remote server. The storage media may be included in a storage device included with or otherwise coupled to, in communication with or attached to a computing device such as a personal computer 110. Storage media include, for example, magnetic media such as hard disks, floppy disks and tape; optical media such as compact disks (CD-ROM and CD-RW), digital versatile disks (DVD and DVD±RW), and high definition disks (e.g., HD-DVD and Blu-ray disks); flash memory cards; and other storage media. As used herein, a storage device is a device that allows for reading from and/or writing to a storage medium. Storage devices include, hard disk drives, DVD drives, media players, high definition media players, flash memory devices, and others. The computer 110 may include a hard disk drive 118.

### COMPONENTS

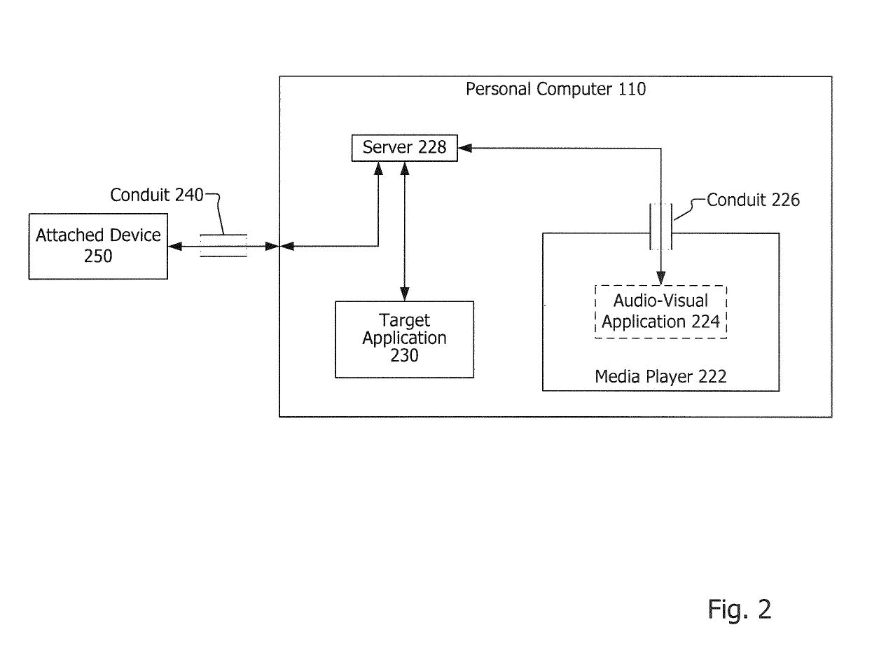

FIG. 2 is a block diagram showing the software and other components of an embodiment of a system that implements a method of extending media player environments. The techniques described herein may be implemented with the components shown in FIG. 2. A personal computer 110 or other computing device may have media player 222 with an included audio-visual application 224, server software 228, a target application 230 and/or an attached device. Generally, the audio-visual application 224 of the media player 222 may access features and functionality of the attached device 250 and/or the target application 230 according to the methods described herein. The audio-visual application 224 may have no audio or visual presentation capability itself, and maybe an application that serves as a client to communicate with the server software 228 to add features to the audio-visual content that plays or executes within the media player 222.

More specifically, the audio-visual application 224 may exist within or accompany the content played back within the media player 22. The audio-visual application 224 complies with a media format specification. The audio-visual application 224 may be referred to as a client or client application. The systems and methods described herein allow audio-visual content to access applications and resources that fall outside the bounds of a network-capable media format specification with which the content complies. The systems and methods described herein may be used to allow audio-visual content to access applications and resources on a personal computer or other platform. The systems and methods may include a server 228 that runs on the local platform along with the media player 222. The content playing within the media player 222 uses the network capabilities of the player to connect to the server 228 on the same system, thus establishing a conduit 226 for sending and receiving data including commands to launch applications, browse documents, etc. In this way, the content may use available network capabilities to circumvent the normal boundaries of the media player application 222 and access external target applications 230 and resources such as attached device 250 via the local server 228.

As used herein, the target applications 230 may be software programs that are stored on and execute on the personal computer 110. The target application 230 may not be aware of the server. The target applications 230 include an Internet browser such as Mozilla Firefox, Opera Software's Opera Web Browser, Microsoft Internet Explorer and Apple Safari. An Internet browser may be augmented with a Java virtual machine. An Internet browser may be augmented with a variety of plug-ins, widgets and other add-ons that provide additional functionality to the Internet browser and provide access to capabilities of and peripherals attached to or incorporated with the personal computer 110. Other target applications 230 are described below.

The attached device 250 may be peripherals to the personal computer 110 or computing device or other devices, including, for example, auxiliary video monitors, speaker systems, media players such as MP3 players, multimedia players such Apple iPod and Microsoft Zune, mobile telephones, PDAs, removable storage systems, printers, odor emitters, liquid sprayers, heaters, coolers, fans, and others. The attached device 250 may not be aware of the server.

The systems and methods described herein involve (1) a media format specification, (2) a software media player 222, and (3) a personal computer 110 or other computing device as described in more detail in the following paragraphs.

A media format specification defines a playback environment for audio-visual content intended for constrained systems, which supports basic networking capabilities, including:

a. The ability to establish a network connection with an arbitrary server

b. The ability to transfer data to and from the server

c. The ability to perform some basic computational processing on that data

Example media format specifications include HD DVD-Video, BD-ROM, and DVB-MHP, also known as MHP.

Content as used herein refers to audio-visual material that may be a movie, television program, musical concert, Broadway show, educational material, seminar, presentation, video game, computer game, other multi-media work, standard or enhanced audio, standard or enhanced video, high definition audio, high definition video stored on a disk complying with a media format specification. The content may be pre-recorded or stored on a hard disk, a video disc or optical disc such as, for example, an HD DVD-Video disc, a BD-ROM disc, and may be streamed or broadcast wirelessly or over various kinds of wired communications media, including, for example, Ethernet cable, cable television coaxial cable and fibre optic cable.

As used herein, a software media player 222 is a software application that complies with the media format specification. Example media players 222 include, for example, without limitation, Microsoft Windows Media Player, RealPlayer, Apple DVD Player, Cyberlink PowerDVD, CyberLink PowerCinema, InterVideo WinDVD, ArcSoft Digital Theatre and Sonic CinePlayer.

As used herein and described above, a PC or other computing device executes the software player application 222. The PC or other computing device may include one or more processors, volatile memory (for example, RAM), non-volatile memory (for example, flash memory, hard disk drive) and a hardware media player 130 or other media player. The PC or other computing device may include processing, memory or storage resources that exceed or are outside of those defined by the format specifications, including the ability to execute multiple concurrent applications in addition to the player.

The audio-visual application 224 software may include some or all of the following sub-components:

a. Software to establish a network connection via conduit 226 with a server 228 on the local PC 110.

b. Software to send commands to and receive commands from the server 228 via conduit 226.

c. Software to send data to and receive data from the server 228 via conduit 226.

d. Software to perform a predefined handshaking operation to determine whether a successful connection has been established with a correct server.

e. Software to interpret and respond to commands received from the server 228.

f. Software to interpret, process and/or display data received from the server 228.

g. Software to securely encrypt commands and data exchanged between the client, namely, audio-visual application 224, and server 228

The server 228 may be a lightweight server application that runs on the PC 110 concurrently with the media player 222. The server 228 may be downloaded from a website, installed from a disc or other media, and may come pre-installed on personal computer 110. The server 228 may start automatically when the personal computer is booted, may start automatically when the operating system on the personal computer is started, may start automatically when the audio-visual application 224 is started, may be invoked by the audio-visual application 224 when access to external applications or devices is requested by content executing via the audio-visual application 224. The server 228 may be invoked manually by the end-user. The server 228 may include some or all the following sub-components:

a. A network listener component that waits for connection requests.

b. A client socket that is used in establishing a connection or conduit 226 between the server 228 and the client, audio-visual application 224.

c. Software to send commands to and receive commands from the client, audio-visual application 224.

d. Software to send data to and receive data from the client, audio-visual application 224.

e. Software to perform a predefined handshaking operation to determine whether a successful connection has been established with a valid client.

f. Software to interpret and respond to commands received from the client, audio-visual application 224.

g. Software to interpret, process and/or display data received from the server 228.

h. Software to securely encrypt commands and data exchanged between the server 288 and the client, audio-visual application 224.

Additional and fewer units, modules or other arrangement of software and data structures may be used to achieve the methods described herein.

### OPERATION

Generally, when the client, the audio-visual application 224, executes within the playback environment, a connection request is sent to the server 228 running on the PC. The server receives the request and uses a conduit 226 such as, for example, a socket or other network conduit, to establish a connection with the client code in the media player. The client (audio-visual application 224) and server 228 may execute a handshaking routine to confirm that a successful and appropriate connection has been established.

After the connection has been confirmed, the client and server may perform one or more of the following operations, thus extending the functionality and capabilities of a media player:

a. The client 224 may send a command to the server 228, such as to launch a target application 230.

b. The client 224 may send data to the server 228 to be relayed to a server-aware application, such as an animation script, instruction set, or security keys for unlocking content.

c. The server 228 may send a command to the client, such as to cease playback of content on a disk in the media player because a subscription time period has expired.

d. The server 228 may send data to the client 224, such as audio-visual content to be decoded and displayed on a personal computer 110, on an attached device 250 and/or on a remote viewing device coupled to a remote computer 152.

e. The client 224 or server 228 may request a security challenge to ensure that a secure connection is established and to ensure that data and commands being exchanged remain protected.

f. The client 224 or server 228 may terminate the connection.

In this manner, the capabilities of the media format are exploited to allow client code executing within the media player to not just connect to an external server on another computer somewhere, but to connect to a lightweight server on the local PC that may then serve as a conduit for commands and data to be transferred outside of the bounds of the media player. By establishing such a connection between the client 224, server 228 and target application 230, data and commands can be exchanged in a seamless and highly synchronized fashion between client 224 and target application 230. Instead of connecting outward to external machines, the network capabilities prescribed by the media format are used to allow content within the player to communicate with applications on the local computing device.

### AN EXAMPLE EMBODIMENT

In one embodiment, the systems and methods may be implemented to provide an enhanced interactive audio-visual application for BD-ROM included in a personal computer. In this embodiment, the client component was written in the Java programming language and took the form of a multi-player trivia game. In this example, the audio-visual application augmented a media player, namely the Cyberlink PowerDVD 6.6 BD Edition player. In various embodiments, the methods described herein may be implemented with other media players that support one or more media format specifications. The server component in this example is implemented as a TCP/IP socket server written in Visual Basic .NET and called “AppLauncher.exe”. In this embodiment, the conduit 226 is a TCP/IP socket. In this embodiment, the target application 230 is Microsoft Internet Explorer.

Other example target applications 230 include (a) other Internet browsers such as Safari, Opera and Firefox; (b) audio and/or video playback or recording software; (c) messaging or chat software; (d) document creation and viewing programs such as Microsoft Word and OpenOffice Writer, and other components of Microsoft Office and OpenOffice; (e) games, and in particular games related to a movie or other content being viewed using the client; (f) communications programs such as file transfer protocol (FTP) to send and/or receive data, images, graphics, etc. to the PC and/or to attached devices 250 such as a music player (e.g., Apple iPod) or game device console (e.g., Sony PlayStation Portable (PSP)); (g) installation programs; (h) subscription verification programs; (i) user authentication and/or verification programs; (j) copy protection and license checking programs; (k) printing applications or utilities; (l) special feature device utilities that control devices included with or coupled with the personal computer, including, for example, light emitting devices, sound effects devices, odor emitting devices, water or spray emitting devices, and others.

Returning to the multi-player trivia game example, at the end of the multi-player trivia game, any player with at least a minimum number of points can select a button labeled “View Original Comic.” Selecting the “View Original Comic” button causes the execution of the client application 224. Selecting the button causes the client application 224 to attempt to connect to the IP address 127.0.0.1 of the PC on port 32778. If a connection is successfully established, the client application 224 receives the text string “What is your wish?” from the server 228. The client 224 issues the command “BROWSE <URL>” (where URL is a Uniform Resource Locator) to the server 228 to open the target application 230, in this example, Internet Explorer or other web browser, to load the specified URL. The connection to the server 228 may then be used for Internet communications via the target application 228/browser and then be closed when the Internet communications are completed.

In this embodiment, the server 228 is a separate application titled “AppLauncher.exe” that runs on the same PC as the client application 224. In this embodiment, the server 228 implements a simple TCP/IP socket server that listens for connection requests on port 32778. When a request is received, a client socket is created to establish a connection or conduit 226 with the requesting client 224. The text string “What is your wish?” is sent from the server 228 to the client 224. The server 228 waits for commands from the client 224. The commands may include, for example, “BROWSE <URL>” or “CMD LAUNCH <executable> <parameters>”. The BROWSE command launches the target application, in this example, Internet Explorer, and displays the specified URL. The CMD LAUNCH command may be used to launch a specified executable file designated by <executable>, a file name such as accessoryApplication.exe, with the specified command line parameters <parameters>. When the client 224 terminates the connection with the server 228, the server 224 may process any remaining commands and terminate the conduit 226, in this example a client socket, and return to a listening state.

### OTHER EMBODIMENTS

Other embodiments of the systems and methods described herein may include some or all of the following features to allow for extension of media players:

a. The server component may be stored on and distributed on a disc (e.g. HD DVD-ROM or BD-ROM disc) such that it automatically launches when inserted into a PC.

b. The media player may be extended to play content received from interactive digital broadcast television systems such as MHP and OCAP, or other television systems which deliver applications that utilize the methods described herein on PC systems to access extended resources.

3. A media player having the server component incorporated therein to provide for more convenient extension of the capabilities of the media player.

4. A server to provide extended resource information to the client, such as the amount or availability of memory, storage, attached devices, or special processing capabilities of the PC or other computing device.

5. A server to provide a client access to extended resources such as memory or storage without dependence on an external target application, such as to store additional content or data.

6. A server to provide a client access to an operating system so that the client may directly access extended resources such as memory or storage to store additional content or other data.

7. A server to provide a conduit for the client to transfer content or data to attached devices. For example the server may provide a conduit to attached devices including, for example, an Apple iPod, MP3 player, music player, Microsoft Zune, or other personal media player attached to the personal computer so that audio-visual content may be downloaded from a disc to the media player.

8. A client and a server pre-installed on game devices and enhanced consumer electronic devices, such as, for example, Sony PlayStation3 or Microsoft Xbox360 game console. The client and server may provide access to extended resources, capabilities or applications offered by the particular device as described herein. The client and server may be stored in a field-programmable gate array (FPGA), flash memory, programmable read-only memory (PROM), programmable logic device (PLD), application-specific integrated circuit (ASIC), or other device included in the computer game device.

### DESCRIPTION OF PROCESSES

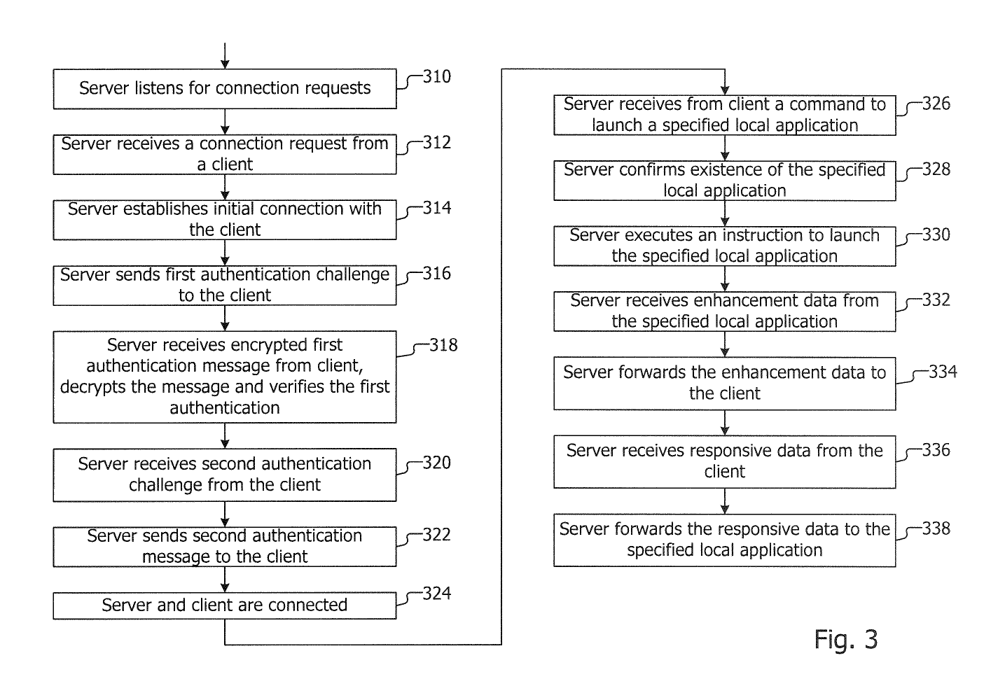

The operation of the systems and methods described herein are shown in the flow diagrams of FIGS. 3, 4A, 4B and 5.

FIG. 3 is a flow chart showing the actions of a server implementing a method of extending media player environments. The server listens for connection requests, as shown in block 310. The server receives a connection request from a client, as shown in block 312. The server establishes an initial connection with the client, as shown in block 314. The server may send a first authentication challenge to the client, as shown in block 316. The server may receive an encrypted first authentication message from the client, decrypt the message and verify the first authentication challenge, as shown in block 318. The server may receive a second authentication challenge from the client, as shown in block 320. The server may send a second authentication message to the client, as shown in block 322. After the authentication has been completed, the server and client are connected, as shown in block 324.

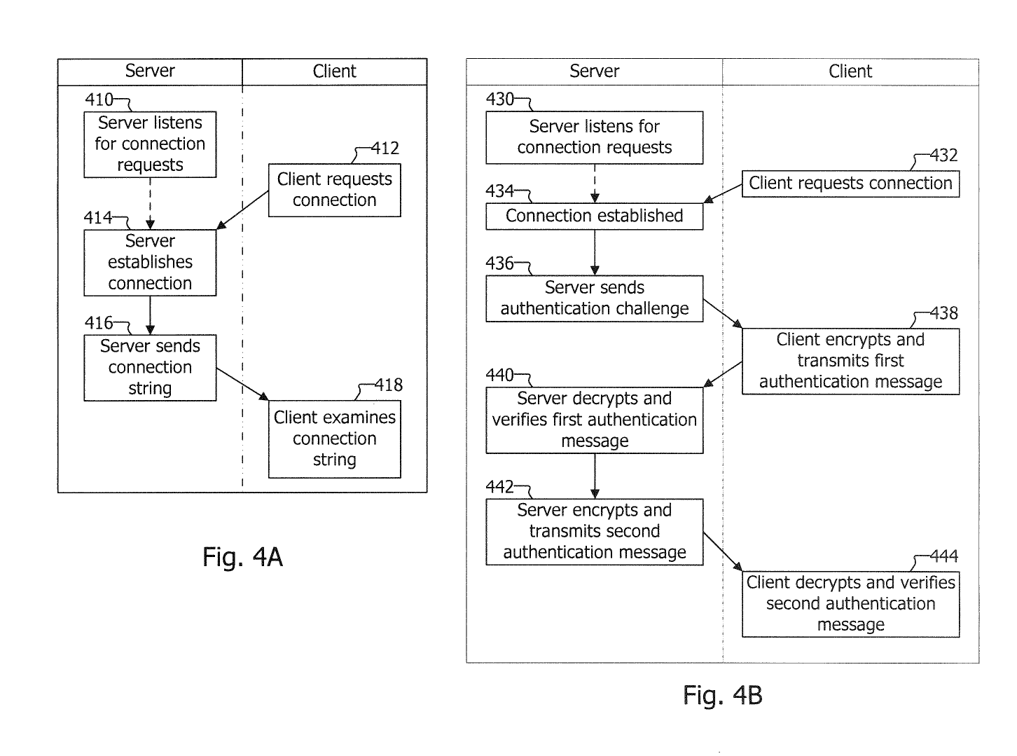

The connection sequence described in blocks 310-324 of FIG. 3 may be implemented in a more simplified manner as shown in FIG. 4A which shows the actions taken by a client and a server in a first embodiment of a client-server connection process.

Referring now to FIG. 4A, the server may listen for connection requests from a client, as shown in block 410. The client may request a connection from the server, as shown in block 412. The server may establish a connection with the requesting client, as shown in block 414. The server may send a connection string to the client, as shown in block 416. The client may examine the connection string, as shown in block 418. A connection would then be established between the client and the server.

Referring now to FIG. 4B, FIG. 4B is a drawing showing the actions taken by a client and a server in a second more involved or more complicated embodiment of a client-server connection process which generally corresponds to the connection sequence described in blocks 310-324 of FIG. 3. As shown in FIG. 4B, the server may listen for connection requests from a client, as shown in block 430. The client may request a connection with the server, as shown in block 432. The server may establish the connection, as shown in block 434. The server may send an authentication challenge to the client, as shown in block 436. The client may encrypt and transmit a first authentication message to the server, as shown in block 438. The server may decrypt and verify the first authentication message, as shown in block 440. The server may encrypt and transmit a second authentication message to the client, as shown in block 442. The client may decrypt and verify the second authentication message, as shown in block 444. A connection would then be established between the client and the server.

Returning now to a discussion of FIG. 3, after a connection is made according to blocks 310-324 of FIG. 3, FIG. 4A and/or FIG. 4B, the server may proceed to implement a method of enhancing video playback. The server may receive from a client a command to launch a specified local application, as shown in block 326. The server may confirm the existence of the specified local application, as shown in block 328. The server may execute one or more instructions to launch the specified local application, as shown in block 330. The server may receive enhancement data from the specified local application, as shown in block 332. As used herein, enhancement data refers to information provided by the local application in response to the client's instructions, for example, additional information about a product, service or movie; information about a character in a movie or game, a musician; lyrics to a song that is included in the content; and others. Other kinds of enhancement data may be provided, including, for example, (a) video or still photos from a personal camera in the form of a video file; (b) audio received from or recorded from a microphone in the form of an audio file; (c) authentication keys for enabling locked content; (d) current date and time from a secure clock in the form of time data; (e) biometric scan results or confirmation such as fingerprint, hand, retina, etc. or other security authorization in the form of biometric data; and (f) game controller input. In this way the system is extensible such that it supports the transfer of digital content between the client and the server.

The server may forward the enhancement data to the client, as shown in block 334. The server may receive responsive data from the client, as shown in block 336. As used herein, responsive data refers to additional commands or information to be sent to a client or attached device to enhance the experience of the content. For example, responsive data may be external device instructions such as a request for the emailing or mailing of additional information about a product or service, a subscriber identifier, a favorite color, a smell description (e.g., skunk or sweet), or other data. Other kinds of responsive data may be provided, including, for example, (a) audio-visual content to be recorded or played back via an external device such as a personal media player, camera, or speakers in the form of audio, image and video files or streams; (b) documents, avatars or images to be printed, displayed or projected in the form of image files, text files and word processing formatted files; (c) usage data to be recorded and/or transferred elsewhere; (d) trace log data from the audio-visual application for use in debugging and testing of the application. The server may forward the responsive data to the specified local application, as shown in block 338.

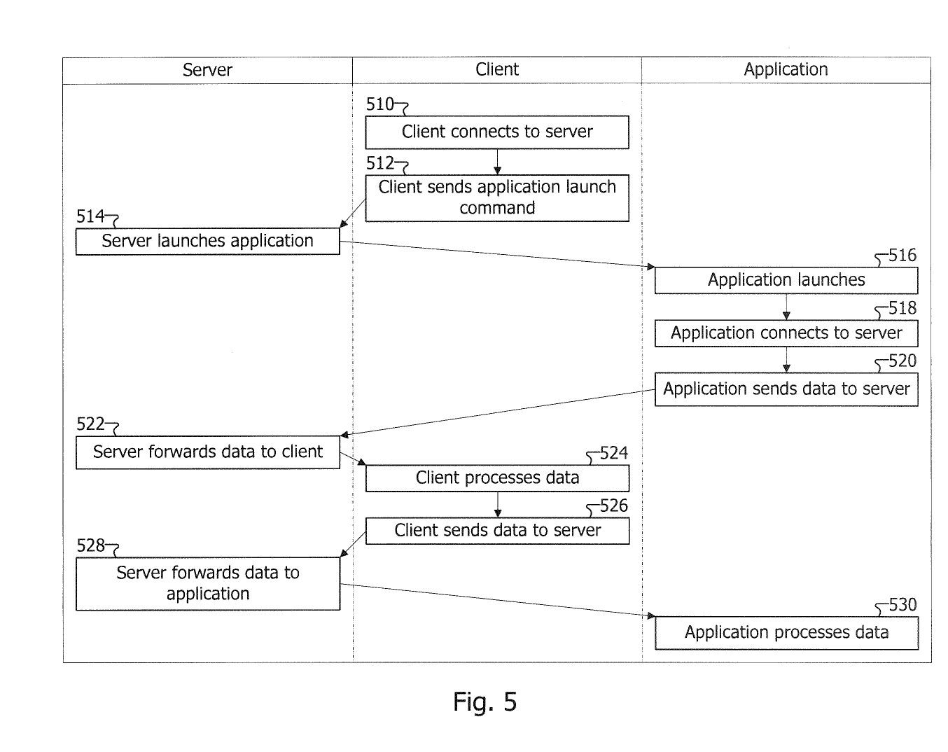

FIG. 5 is a drawing showing the actions taken by a client and a server to launch an application to extend a media player environment. The client connects to a server, as shown in block 510. This connection may be made pursuant to blocks 310-324 of FIG. 3, FIG. 4A, and/or FIG. 4B. The client may send an application launch command or commands to the server as shown in block 512. The server may launch the client specified application, as shown in block 514. The application may launch, as shown in block 516. The application may connect to the server, as shown in block 518. The application may send data to the server, as shown in block 520. The server may forward data to the client, as shown in block 522. The client may process the data, as shown in block 524. The client may send data to the server, as shown in block 526. The server may forward the data to the application, as shown in block 528. The application may process the data, as shown in block 530.

### CLOSING COMMENTS

The foregoing is merely illustrative and not limiting, having been presented by way of example only. Although examples have been shown and described, it will be apparent to those having ordinary skill in the art that changes, modifications, and/or alterations may be made.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A method for extending the capabilities of a media player included with a computing device, the method comprising:
establishing a connection with a client application executing from a media player
receiving from the client application a request to launch a local application on the computing device
launching the local application.

2. The method of claim 1 further comprising:
communicating data between the client application and the local application to enhance a content when the content is played on the media player.

3. The method of claim 1 wherein the content is stored on a hard disk, a DVD disc, a BLU-RAY disc, or an HD-DVD disc.

4. The method of claim 1 wherein the content is a digital television broadcast.

5. The method of claim 1 wherein the media player conforms to one or both of a BLU-RAY and an HD-DVD standard.

6. The method of claim 1 wherein the content conforms to one of the Digital Video Broadcasting Multimedia Home Platform (DVB-MHP), OpenCable Application Platform (OCAP) and Globally Executable MHP (GEM) standards.

7. The method of claim 1 wherein the local application is an Internet browser.

8. The method of claim 1 wherein the communicating data between the client application and the local application to enhance the content includes:
receiving a responsive data from the client application
forwarding the responsive data to the local application, wherein the local application uses the responsive data to enhance the content
wherein the responsive data is at least one from the group including an audio file, a still photo, an avatar, a video file, a text file, external device control instructions
wherein the enhancement data is at least one from the group including an audio file, a still photo, an avatar, game controller input, biometric scan data, a video file.

9. The method of claim 1 wherein the communicating data between the client application and the local application to enhance the content includes:
receiving an enhancement data from the local application
forwarding the enhancement data to the client application, wherein the client application uses the enhancement data to enhance the content.

10. A storage medium having instructions stored thereon which when executed cause a computing device to perform actions comprising:
establishing a connection with a client application executing in a media player
receiving from the client application a request to launch a local application on the computing device
launching the local application
communicating data between the client application and the local application to enhance a content when the content is played on the media player.

11. The storage medium of claim 10 having further instructions stored thereon which when executed cause the computing device to perform further actions comprising:
communicating data between the client application and the local application to enhance a content when the content is played on the media player.

12. The storage medium of claim 10 wherein the storage medium is one of a hard disk, a DVD disc, a BLU-RAY disc or an HD-DVD disc.

13. The storage medium of claim 10 wherein the media player conforms to one or both of a BLU-RAY and an HD-DVD standard.

14. The storage medium of claim 10 wherein the communicating data between the client application and the local application to enhance the content includes:
receiving a responsive data from the client application
forwarding the responsive data to the local application, wherein the local application uses the responsive data to enhance the content
wherein the responsive data is at least one from the group including an audio file, a still photo, an avatar, a video file, a text file, external device control instructions
wherein the enhancement data is at least one from the group including an audio file, a still photo, an avatar, game controller input, biometric scan data, a video file.

15. The storage medium of claim 10 wherein the communicating data between the client application and the local application to enhance the content includes:
receiving a enhancement data from the local application
forwarding the enhancement data to the client application, wherein the client application uses the enhancement data to enhance the content.

16. A computing device comprising:
a processor, a memory coupled with the processor, a user input device, a display, a media player, and a storage medium having instructions stored thereon which when executed cause the computing device to perform actions comprising:
establishing a connection with a client application executing in the media player
receiving from the client application a request to launch a local application on the computing device
launching the local application
communicating data between the client application and the local application to enhance a content when the content is played on the media player.

17. The computing device of claim 16 wherein the storage medium is one of a hard disk, a DVD disc, a BLU-RAY disc or an HD-DVD disc.

18. The computing device of claim 16 wherein the media player conforms to one or both of a BLU-RAY and an HD-DVD standard.

19. The computing device of claim 16 wherein the content is a cable television broadcast.

20. The computing device of claim 16 wherein the content conforms to one of the Digital Video Broadcasting Multimedia Home Platform (DVB-MHP), OpenCable Application Platform (OCAP) and Globally Executable MHP (GEM) standards.

21. The computing device of claim 16 wherein the local application is an Internet browser.

22. The computing device of claim 16 wherein the communicating data between the client application and the local application to enhance the content includes:
receiving a responsive data from the client application
forwarding the responsive data to the local application, wherein the local application uses the responsive data to enhance the content
wherein the responsive data is at least one from the group including an audio file, a still photo, an avatar, a video file, a text file, external device control instructions
wherein the enhancement data is at least one from the group including an audio file, a still photo, an avatar, game controller input, biometric scan data, a video file.

23. The computing device of claim 16 wherein the communicating data between the client application and the local application to enhance the content includes:
receiving an enhancement data from the local application
forwarding the enhancement data to the client application, wherein the client application uses the enhancement data to enhance the content.

24. A method for extending the capabilities of a media player included with a computing device, the method comprising:
establishing a connection with a client application executing from a media player
receiving from the client application a request to access an external device
communicating data between the client application and the external device to enhance a content when the content is played on the media player.

25. The method of claim 24 wherein the external device is one of a personal media player, video game console or cellular telephone.
